(19) United States
(12) Patent Application Publication
(10) Pub. No.: US 2024/0235242 A1
(43) Pub. Date: Jul. 11, 2024

(54) SYSTEMS AND METHODS FOR INTERFACING WITH BATTERIES HAVING DIFFERENT CHARGING CHARACTERISTICS

(71) Applicant: SCHNEIDER ELECTRIC IT CORPORATION, Foxboro, MA (US)

(72) Inventors: Sheng-Hsien Fang, New Taipei City (TW); Pradeep Tolakanahalli Nagabhushanrao, Bangalore (IN); Chandrasekaran Jayaraman, Bangalore (IN)

(21) Appl. No.: 18/407,049

(22) Filed: Jan. 8, 2024

Related U.S. Application Data
(60) Provisional application No. 63/479,066, filed on Jan. 9, 2023.

(51) Int. Cl. H02J 7/00

(52) U.S. Cl. CPC H02J 7/007182; H02J 7/0013; H02J 2207/20

(57) ABSTRACT

According to an example of the disclosure, a battery-management system is provided including a first group of one or more switching devices, each being configured to be coupled to a power bus, a second group of one or more switching devices configured to be coupled to a battery, each switching device of the second group being coupled to the first group of one or more switching devices, a buck/boost charger coupled to the first group of one or more switching devices and being configured to be coupled to the battery, the buck/boost charger being further configured to adjust a voltage of charging power provided to the battery, and at least one controller configured to control the buck/boost charger to adjust the voltage of the charging power based on a rated voltage of the battery and based on an input voltage of input power received from the power bus.

### CROSS-REFERENCE TO RELATED APPLICATIONS

This application claims priority under 35 U.S.C. § 119(e) to U.S. Provisional Application Ser. No. 63/479,066, titled “COMPATABILE SYSTEM FOR BATTERY PACKS WITH MULTIPLE CELL CHEMISTRIES,” filed on Jan. 9, 2023, which is hereby incorporated by reference in its entirety.

### BACKGROUND

### 1. Field of the Disclosure

At least one aspect of the present disclosure relates to batteries and charging batteries.

### 2. Discussion of Related Art

Batteries of different types may have different chemistries. A battery having one cell chemistry may operate at a different voltage than a battery having a different cell chemistry. For example, a rated charging voltage for a battery may depend at least in part on the cell chemistry of the battery.

### SUMMARY

According to at least one aspect of the present disclosure, a battery management system (BMS) is provided. The BMS comprises a power bus; a return bus; a first group of one or more switching devices, each switching device of the first group being coupled to the power bus; a second group of one or more switching devices configured to be coupled to a battery, each switching device of the second group being coupled to the first group of one or more switching devices; a charger coupled to the first group of one or more switching devices and being configured to be coupled to the battery, the charger being further configured to adjust a voltage of charging power provided to the battery; and at least one controller configured to control the first group of one or more switching devices, the second group of one or more switching devices, and the charger to adjust the voltage of the charging power based on a charging voltage of the battery and based on an input voltage of power provided via the power bus.

In some examples, the BMS further comprises one or more diodes including a first diode coupled in parallel with the first group of one or more switching devices, and a second diode coupled in parallel with the second group of one or more switching devices. In various examples, the charger is coupled in parallel with the second group of one or more switching devices. In many examples, the second group of one or more switching devices is coupled in series with the first group of one or more switching devices between the power bus and the battery. In some examples, the at least one controller is further configured to receive voltage information indicative of a voltage of the battery and indicative of the input voltage.

In various examples, the BMS further comprises a resistor coupled in series between the battery and the return bus. In many examples, the at least one controller is further configured to operate one or more switching devices of the first group of one or more switching devices and one or more switching devices of the second group of one or more switching devices to couple the power bus to the battery via the one or more switching devices of the second group of one or more switching devices responsive to determining that the voltage of the battery is below the input voltage. In various examples, the at least one controller is further configured to operate one or more switching devices of the second group of one or more switching devices to decouple the power bus from the battery via the one or more switching devices of the second group of one or more switching devices and to turn on the charger responsive to determining that the voltage of the battery is within a first threshold voltage amount of the input voltage. In some examples, the at least one controller is further configured to turn off the charger responsive to determining that the voltage of the battery is within a second threshold voltage amount of the charging voltage.

In various examples, the at least one controller is further configured to operate each switching device of the second group of one or more switching devices to decouple the power bus from the battery via the one or more switching devices of the second group of one or more switching devices and to turn on the charger responsive to determining that the voltage of the battery is within a first threshold voltage amount of the charging voltage. In many examples, the at least one controller is further configured to turn off the charger responsive to determining that the voltage of the battery is within a second threshold voltage amount of the charging voltage.

According to at least one aspect of the present disclosure, a system for charging multiple batteries using a single power bus is provided. The system comprises a power bus configured to provide input voltage; and a plurality of battery-management systems (BMSs) including a first BMS and a second BMS coupled in parallel with the first BMS, the first BMS and the second BMS being coupled to the power bus and being configured to receive the input voltage, each BMS of the plurality of BMSs including: at least one charger; at least one first switching device coupled to the power bus; at least one second switching device coupled in parallel with at least one charger and coupled to the at least one first switching device, the at least one second switching device being configured to be coupled to a battery, and the at least one charger being configured to be coupled to the battery; and at least one controller coupled to the at least one first switching device, the at least one second switching device, and the at least one charger, the at least one controller being configured to: determine a voltage provided via the power bus; determine a voltage of the battery; and control the at least one first switching device, the at least one second switching device, and the at least one charger to adjust, based on the voltage of the power bus and the voltage of the battery, a voltage provided to the battery.

In various examples, a string voltage of the first BMS is greater than a string voltage of the second BMS. In some examples, the at least one controller of the first BMS is further configured to control the at least one charger of the first BMS to boost or buck the voltage provided via the power bus to be within a threshold voltage amount of the string voltage of the battery of the first BMS responsive to determining that the voltage provided via the power bus does not equal the string voltage. In many examples, the at least one controller of the first BMS is configured to control the at least one charger of the first BMS to buck the voltage of the power bus responsive to determining that the string voltage of the first BMS is less than the voltage of the power bus.

In various examples, the at least one controller of the first BMS is configured to control the at least one charger of the first BMS to boost the voltage of the power bus responsive to determining that the string voltage of the first BMS is greater than the voltage of the power bus.

According to at least one aspect of the present disclosure, a method of charging multiple batteries connected to a power bus is provided. The method comprises receiving, at an input of a first battery-management system (BMS), input power having a voltage; comparing the voltage with a string voltage of the first BMS to determine whether the voltage is greater than or less than the string voltage of the first BMS; providing adjusted power having an adjusted voltage to a battery of the first BMS, the input power being adjusted based on whether the voltage is greater or less than the string voltage of the first BMS; receiving the input power at an input of a second BMS; comparing the voltage with a string voltage of the second BMS to determine whether the voltage is greater than or less than the string voltage of the second BMS; and providing adjusted power having an adjusted voltage to a battery of the second BMS based on whether the voltage is greater or less that the string voltage of the second BMS.

In various examples, providing the adjusted power having the adjusted voltage to the battery of the first BMS includes boosting the voltage to equal the string voltage of the first BMS responsive to determining that the voltage is less than the string voltage of the first BMS. In some examples, providing the adjusted power having the adjusted voltage to the battery of the first BMS includes reducing the voltage to equal the string voltage of the first BMS responsive to determining that the voltage is greater than the string voltage of the first BMS.

According to at least one aspect of the present disclosure, a non-transitory computer-readable medium storing thereon instruction for instructing at least one processor is provided. The non-transitory computer-readable medium stores instructions instructing the at least one processor to detect a voltage of input power provided via a power bus to a battery; compare the voltage to a string voltage of the battery; and control a first plurality of switching devices, a second plurality of switching devices, and a charger to provide an adjusted voltage based on the comparison of the voltage of the input power to the string voltage of the battery.

In some examples, the instructions further instruct the at least one processor to operate the first plurality of switching devices and the second plurality of switching devices to couple the input to the battery via the first plurality of switching devices and the second plurality of switching devices responsive to determining that a voltage of the battery is less than the voltage of the input power and less than the string voltage. In various examples, the instructions further instruct the at least one processor to operate the second plurality of switching devices to decouple the input from the battery via the second plurality of switching devices and turn on the charger responsive to determining that a voltage of the battery is within a first threshold voltage amount of the string voltage. In at least one examples, the instructions further instruct the at least one processor to turn off the charger responsive to determining that the voltage of the battery is within a second threshold voltage amount of the string voltage. In many examples, the adjusted voltage is greater than the voltage of the input power. In various examples, the adjusted voltage is less than the voltage of the input power.

Aspects of the disclosure include a battery-management system (BMS) comprising a first group of one or more switching devices, each switching device of the first group being configured to be coupled to a power bus, a second group of one or more switching devices configured to be coupled to a battery, each switching device of the second group being coupled to the first group of one or more switching devices, a buck/boost charger coupled to the first group of one or more switching devices and being configured to be coupled to the battery, the buck/boost charger being further configured to adjust a voltage of charging power provided to the battery, and at least one controller configured to control the buck/boost charger to adjust the voltage of the charging power based on a rated voltage of the battery and based on an input voltage of input power received from the power bus.

In at least one example, the BMS includes one or more diodes including a first diode coupled in parallel with the first group of one or more switching devices, and a second diode coupled in parallel with the second group of one or more switching devices. In at least one example, the buck/boost charger is coupled in parallel with the second group of one or more switching devices. In at least one example, the second group of one or more switching devices is configured to be coupled in series with the first group of one or more switching devices between the power bus and the battery.

In at least one example, the at least one controller is further configured to operate the buck/boost charger to boost the voltage of the charging power responsive to determining that the rated voltage of the battery is greater than the input voltage. In at least one example, the at least one controller is further configured to operate the buck/boost charger to buck the voltage of the charging power responsive to determining that the rated voltage of the battery is less than the input voltage.

Aspects of the disclosure include a method of operating a battery system including a buck/boost charger and being configured to be coupled to a battery, the method comprising receiving, at an input of the battery system, input power from a power bus, determining a voltage of the input power, determining a rated voltage of the battery, comparing the voltage of the input power to the rated voltage of the battery, and operating the buck/boost charger to provide a charging current derived from the input power to the battery, wherein providing the charging current includes controlling the buck/boost charger to adjust the voltage of the input power based on comparing the voltage of the input power to the rated voltage of the battery.

In at least one example, controlling the buck/boost charger to adjust the voltage of the input power includes controlling the buck/boost charger to boost the voltage of the input power responsive to determining that the voltage of the input power is less than the rated voltage of the battery. In at least one example, controlling the buck/boost charger to adjust the voltage of the input power includes controlling the buck/boost charger to buck the voltage of the input power responsive to determining that the voltage of the input power is greater than the rated voltage of the battery.

In at least one example, the method includes operating, at a first time while the battery system is coupled to a first battery having a first rated voltage, the buck/boost charger to provide a first charging current derived from the input power to the first battery, wherein providing the first charging current includes controlling the buck/boost charger to boost the voltage of the input power responsive to determining that the voltage of the input power is less than the first rated voltage of the first battery, and operating, at a second time while the battery system is coupled to a second battery having a second rated voltage, the buck/boost charger to provide a second charging current derived from the input power to the second battery, wherein providing the second charging current includes controlling the buck/boost charger to buck the voltage of the input power responsive to determining that the voltage of the input power is greater than the second rated voltage of the second battery.

Aspects of the disclosure include a system for charging multiple batteries using a single power bus, the system comprising a power bus configured to provide input power having an input voltage, and a plurality of battery-management systems (BMSs) including a first BMS and a second BMS coupled in parallel with each other, the first BMS and the second BMS being coupled to the power bus and being configured to receive the input power, each BMS of the plurality of BMSs including at least one buck/boost charger configured to be coupled to a respective battery, at least one first switching device coupled to the power bus, at least one second switching device coupled in parallel with at least one buck/boost charger and coupled to the at least one first switching device, the at least one second switching device being configured to be coupled to the respective battery, and at least one controller coupled to the at least one first switching device, the at least one second switching device, and the at least one buck/boost charger, the at least one controller being configured to determine the input voltage, determine a rated voltage of the respective battery, and control the at least one buck/boost charger to provide a charging current derived from the input power to the battery, wherein providing the charging current includes adjusting the input voltage based on the rated voltage of the respective battery.

In at least one example, the first BMS is configured to be coupled to a first battery having a first rated voltage, and the second BMS is configured to be coupled to a second battery having a second rated voltage different than the first rated voltage. In at least one example, the at least one controller of the first BMS is further configured to control the at least one buck/boost charger of the first BMS to boost the input voltage responsive to determining that the input voltage is less than the first rated voltage. In at least one example, the at least one controller of the second BMS is configured to control the at least one buck/boost charger of the second BMS to buck the input voltage responsive to determining that the second rated voltage is less than the input voltage. In at least one example, the at least one controller of the second BMS is configured to control the at least one buck/boost charger of the second BMS to buck the input voltage responsive to determining that the second rated voltage is less than the input voltage.

Aspects of the disclosure include a method of charging multiple batteries connected to a power bus, the method comprising receiving, by a first battery-management system (BMS) coupled to a first battery having a first rated voltage, first input power having an input voltage from the power bus, comparing the input voltage with the first rated voltage to determine whether the input voltage is greater than or less than the first rated voltage, operating a first buck/boost charger of the first BMS to adjust the input voltage based on comparing the input voltage with the first rated voltage, receiving, by a second BMS coupled to a second battery having a second rated voltage, second input power having the input voltage from the power bus, comparing the input voltage with the second rated voltage to determine whether the input voltage is greater than or less than the second rated voltage, and operating a second buck/boost charger of the second BMS to adjust the input voltage based on comparing the input voltage with the second rated voltage.

In at least one example, operating the first buck/boost charger of the first BMS to adjust the input voltage based on comparing the input voltage with the first rated voltage includes boosting the input voltage responsive to determining that the input voltage is less than the first rated voltage. In at least one example, operating the second buck/boost charger of the second BMS to adjust the input voltage based on comparing the input voltage with the second rated voltage includes bucking the input voltage responsive to determining that the input voltage is greater than the second rated voltage. In at least one example, operating the second buck/boost charger of the second BMS to adjust the input voltage based on comparing the input voltage with the second rated voltage includes bucking the input voltage responsive to determining that the input voltage is greater than the second rated voltage. In at least one example, operating the second buck/boost charger of the second BMS to adjust the input voltage based on comparing the input voltage with the second rated voltage includes boosting the input voltage responsive to determining that the input voltage is less than the second rated voltage.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a schematic diagram of a battery management system according to an example;

FIG. 2 illustrates a process for charging a battery using the battery management system according to an example;

FIG. 3A illustrates a graph of operation of the battery management system during a charging process according to an example;

FIG. 3B illustrates a graph of operation of the battery management system during a charging process according to another example;

FIG. 4 illustrates a process for discharging a battery using the battery management system according to an example; and

FIG. 5 illustrates an uninterruptible power supply system with multiple batteries connected in parallel according to an example.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Batteries of various types may have different internal chemistries or cell materials. For example, lead-acid batteries typically have reservoirs of electrolytes (for example, a sulfuric acid mixture) separated by lead plates. The plates act as anodes and cathodes. When the battery is discharged, the electrolytes undergo a chemical reaction converting the electrolytes into a chemically different material and releasing energy. Lead-acid batteries can be recharged by reversing the current and thus reversing the chemical reaction. By contrast, lithium-ion batteries may use a lithium-cell material that undergoes an oxidation half-reaction at the anode to produce positively charged lithium ions and negatively charged electrons (and thus, an internal electromagnetic field). Lithium-ion batteries can be recharged by reversing the reaction in a similar manner to the lead acid battery. Lithium-ion batteries may be implemented according to various cell chemistries, such as lithium cobalt oxide (LiCoO2), lithium manganese oxide (LiMn2O4), lithium iron phosphate (LiFePO4), and so forth. Many other battery chemistries also exist.

Batteries with different cell chemistries may have different charging and discharging voltages. As a battery is recharged, its voltage may increase until reaching a rated fully charged voltage of the battery. Thus, when charging or recharging a battery of a given chemistry, it may be advantageous to apply a certain voltage to the battery. Likewise, when charging (or recharging) a battery of a different chemistry, it may be advantageous to apply a different voltage to the battery. For example, it may be advantageous to apply a voltage that is at least equal to or greater than the rated fully charged voltage of the battery. Otherwise, it may not be possible or feasible to fully recharge the battery.

Battery packs may include a string of one or more battery cells and a battery-management system (BMS). The BMS may include charging circuitry (and, in some examples, discharging circuitry). The BMS may control the charging circuitry to provide recharging power to the battery cells. For example, the BMS may control the charging circuitry to draw power from a power source (for example, an uninterruptible power supply [UPS]), adjust a voltage level of the drawn power, and provide the adjusted power to the battery cells.

Adjusting the voltage level of the drawn power may include increasing (that is, boosting) or decreasing (that is, bucking) the voltage level of the drawn power to a voltage level suitable for charging the battery cells. As discussed above, different cell chemistries may have different corresponding rated charging voltages. Accordingly, the BMS may control the charging circuitry to adjust the voltage of the drawn power to a rated charging voltage for the battery cells (which may vary between different cell chemistries) to recharge the battery cells.

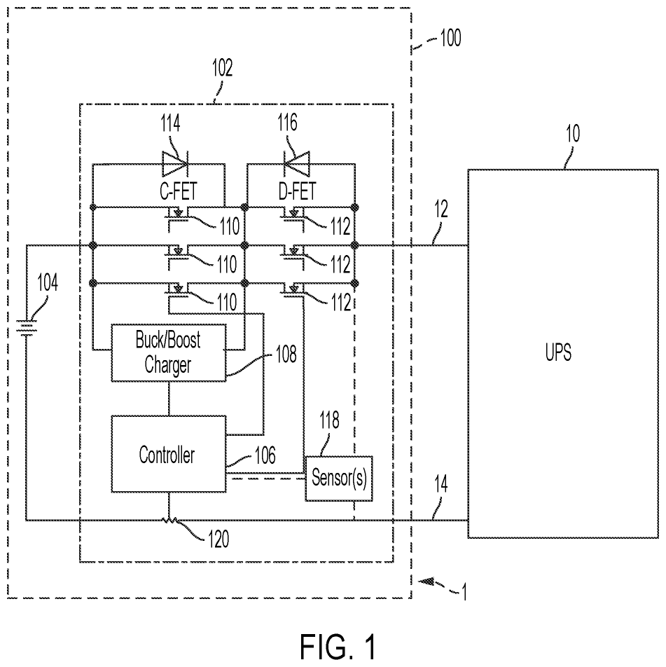

FIG. 1 illustrates a system 1 including an uninterruptible power supply 10 (“UPS 10”) and a battery pack 100 according to an example. The battery pack 100 includes a battery-management system 102 (“BMS 102”) and a battery string of one or more battery cells 104 (“battery 104”). Amongst other functions, the BMS 102 is configured to draw power from the UPS 10, adjust a voltage level of the drawn power based at least in part on the cell chemistry of the battery 104, and provide the adjusted power to the battery 104 to recharge the battery 104.

The UPS 10 is coupled to the BMS 102 via a DC battery power bus 12 (“power bus 12”) and a DC battery return bus 14 (“return bus 14”). The UPS 10 may also be coupled to a main power source (not pictured), such as a utility power supply. When main power is unavailable, the UPS 10 may draw power from the BMS 102 via the busses 12, 14 in order to power one or more loads (not pictured). When main power is available, the UPS 10 may power the loads using main power. If the battery 104 is not fully charged while main power is available, the BMS 102 may draw power from the UPS 10 (referred to herein as “charging power,” or “recharging power”) to recharge the battery 104.

The BMS 102 includes at least one battery-management-system controller 106 (“controller 106”), a buck/boost converter 108 (“converter 108,” “buck/boost converter 108,” or “charger 104”), a first group of one or more switching devices 112, a second group of one or more switching devices 110, a plurality of diodes including a first diode 114 and a second diode 116, and one or more sensors 118 (“sensors 118”). In some examples, the first group of one or more switching devices 112 may include three D-FETs, and the second group of one or more switching devices 110 may include three C-FETs, for purposes of example. For case of explanation, the first group of one or more switching devices 112 may be referred to as “D-FETs 112,” the second group of one or more switching devices 110 may be referred to as “C-FETs 110,” and the two groups of one or more switching devices 110, 112, may be referred to as “FETs 110, 112.” In other examples, however, the groups of one or more switching devices 110, 112 may each include more or fewer than three switching devices, and may each include switching devices other than (or in addition to) C-FETs and/or D-FETs.

The controller 106 is coupled to the converter 108, the C-FETs 110, the D-FETs 112, and the sensors 118. The controller 106 may control the converter 108 and the FETs 110, 112. For example, the controller 106 can control the converter 108 to operate in a boost mode or a buck mode, and can control the FETs 110, 112 to turn on (that is, to conduct) and/or off (that is, to not conduct). In some examples, a switching device of a different type (for example, a BJT, IGBT, a relay, and so forth) may be used in addition to, and/or in lieu of, the FETs 110, 112. The controller 106 may also be configured to receive sensed voltage and/or current information from the sensors 118. The sensed information may be indicative of a voltage and/or a current on either or both of the busses 12, 14.

The converter 108 is coupled to the D-FETs 112 and second diode 116 at a first connection, is coupled to the battery 104 at a second connection, and is coupled in parallel with the C-FETs 110 and the first diode 114.

The C-FETs 110 are coupled in parallel with one another, with the converter 108, and with the first diode 114. Each of the C-FETs 110 is coupled to the battery 104 at a first respective connection, is coupled to the D-FETs 112 and the second diode 114 at a second respective connection, and is communicatively coupled to the controller 106. The first diode 114 is coupled to the battery 104 at an anode connection, is coupled to the D-FETs 112 and the second diode 116 at a cathode connection, and is coupled in parallel with the converter 108 and the C-FETs 110.

The D-FETs 112 are coupled in parallel with one another and with the second diode 116. Each of the D-FETs 112 is coupled to the power bus 12 at a first respective connection, is coupled to the converter 108, the C-FETs 110, and the first diode 114 at a second respective connection, and is communicatively coupled to the controller 106. The second diode 116 is coupled to the power bus 12 at an anode connection, is coupled to the converter 108, the C-FETs 110, and the first diode 114 at a cathode connection, and is coupled in parallel with the D-FETs 112.

In some examples, the parallel combination of the D-FETs 112 and second diode 116 is coupled in series with the parallel combination of the converter 108, the C-FETs 110, and the first diode 114 between the power bus 12 and the battery 104.

In some examples, the BMS 102 further includes a resistor 120 coupled between the battery 104 and the return bus 14. In some examples, the resistor 120 is coupled in series between the battery 104 and the return bus 14. In various examples, the resistor 120 may be a variable resistor coupled to the controller 106. The controller 106 may control a resistance value of the resistor 120 in examples in which the resistor 120 is a variable resistor.

The controller 106 includes and/or is coupled to storage and/or memory configured to store at least one rated voltage value (“rated voltage”) corresponding to the charging and/or recharging voltages of the battery 104. For example, the rated voltage may include the rated voltage of the battery 104 when the battery 104 is fully charged (that is, having a state-of-charge above a threshold level). In various examples, the rated voltage may be specified by a manufacturer of a respective battery.

The rated voltage may differ from the voltage of power that is provided from the UPS 10 to the BMS 102 to charge or recharge the battery 104. For example, the voltage provided by the UPS 10 (or the “UPS voltage”) may be approximately 54 V, but the rated voltage of the battery 104 may be 52 V, 56 V, 58 V, or some other value. As discussed in greater detail below, the BMS 102 is configured to adjust the UPS voltage to a level suitable for recharging the battery 104. In this manner, the BMS 102 is compatible with batteries of multiple different cell chemistries having multiple different rated voltages because the BMS 102 may accommodate different rated voltages for a fixed UPS voltage.

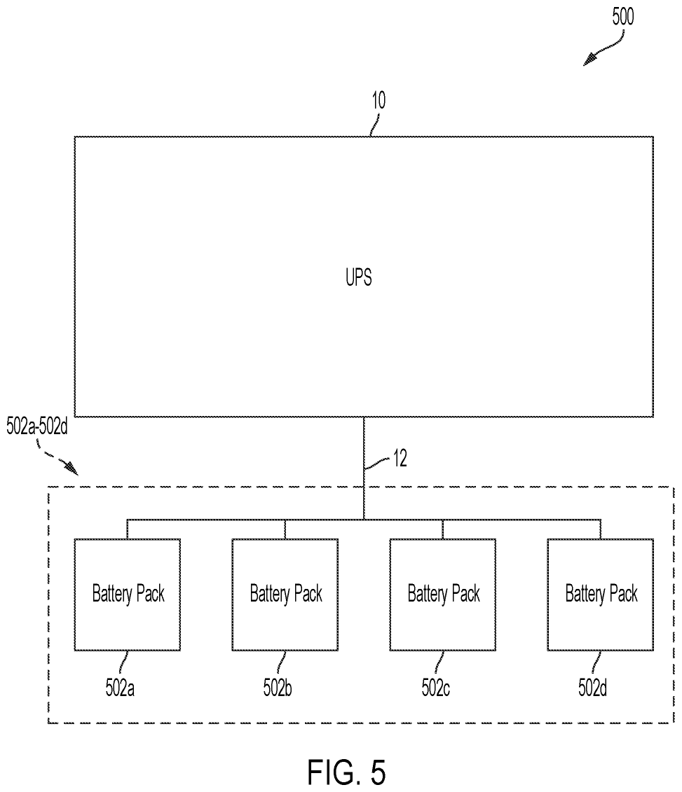

The converter 108 can boost the UPS voltage and/or buck the UPS voltage. The converter 108 may also provide trickle charging to the battery 104. When the UPS voltage exceeds a desired charging voltage, the converter 108 may buck the UPS voltage. When the UPS voltage drops below the charging voltage, the converter 108 may boost the UPS voltage. Consider multiple battery packs 502a-502d connected in parallel to the UPS 10 (as shown in FIG. 5). Suppose each respective battery 104 of each of the battery packs 502a-502d includes a battery having a different rated voltage. The respective BMS of each of the battery packs 502a-502d can then buck or boost the UPS voltage to equal the respective rated voltage of each respective one of the battery packs 502a-502d. Each battery can thus effectively charge at the same time in a safe manner. In this manner, multiple batteries having different cell chemistries may be connected (via a respective BMS) to a single UPS.

The various FETs 110, 112 conduct current from the UPS 10 to the battery 104 or from the battery 104 to the UPS 10. The FETs 110, 112 may be controlled to open and close by the controller 106. As discussed above, the FETs 110, 112 may each include any number of FETs, including one FET. In examples with more than one C-FET 106 and/or D-FET 108, one or more of the respective FETs 110, 112 may be turned on. When only a single C-FET 106 and single D-FET 108 is turned on, the rated charging current (or rated discharging current) between the UPS 10 and the BMS 102 may be less than when more FETs 110, 112 are turned on. In general, for each additional pair of C-FET 106 and D-FET 108 turned on the maximum rated current that can transfer between the UPS 10 and the BMS 102 increases. In some examples, the increase in maximum current is proportional to the number of pairs of C-FET 106 and D-FET 108 turned on. When all the C-FETs 110 and D-FETs 112 are turned off, no appreciable current exists between the battery 104 and the UPS 10.

The sensors 118 may sense a voltage, current, power, and/or other characteristics related to electrical signals (collectively “power characteristics”). The sensors 118 may be configured to provide information indicative of one or more of the power characteristics of power exchanged between the battery 104 and the UPS 10 to the controller 106. In some examples, the sensors 118 are coupled to one or more of the battery 104 (or an input or output of the battery 104), a connection corresponding to the connection between the power bus 12 and the D-FETs 112, the input and/or output of the converter 108, the return bus 16, a combination of the foregoing, and so forth. The sensors 118 may provide information indicative of the power characteristics of any electrical signal, current, energy, or so forth, present at any desired location in the system 1 to the controller 106.

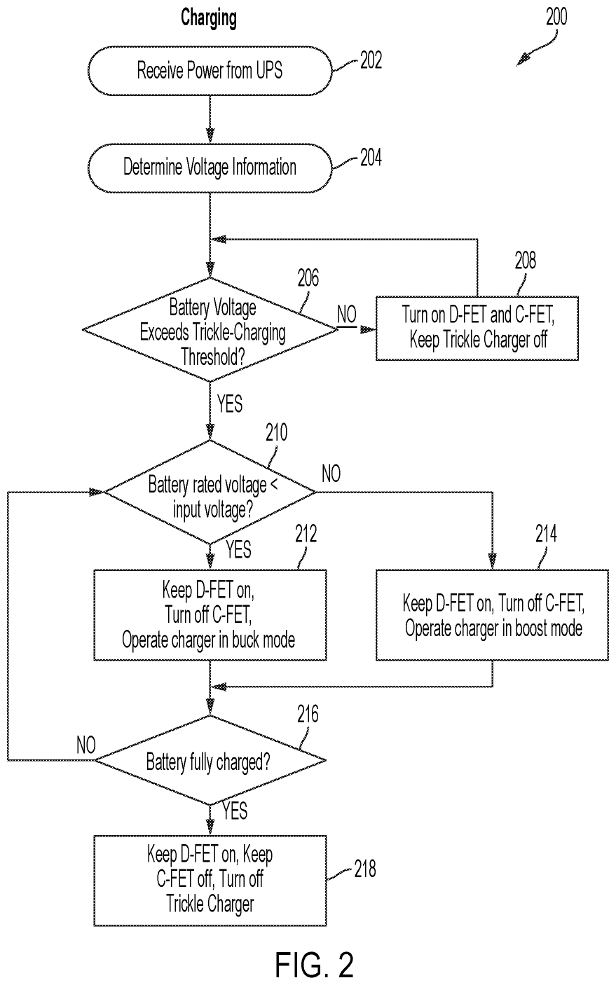

FIG. 2 illustrates a process 200 of operating the BMS 102 during a charging mode. During one example of the process 200, the battery 104 is not yet fully charged. For example, the battery 104 may have recently discharged stored energy to the UPS 10. In the example provided below, the UPS 10 may have regained access to main power from a main-power source, and is capable of providing charging power to the BMS 102 via the busses 12, 14.

At act 202, the BMS 102 receives power from the UPS 10 via the busses 12, 14. As noted above, the UPS 10 may have access to main power from a main-power source, such as a utility grid. The UPS 10 may include a DC/DC converter (not illustrated) that converts power on an internal UPS DC bus line to a suitable voltage level across the busses 12, 14, such as up to 54 V DC (or some other value in other examples).

At act 204, the controller 106 obtains voltage information for the battery pack 100. Voltage information may include present sensed voltage information and/or stored voltage-rating information. Sensed voltage information may be received from the sensors 118. For example, the sensors 118 may include voltage sensors configured to sense a voltage of power received from the UPS 10, such as a voltage across the busses 12, 14 (referred to below as the UPS voltage), a voltage across the battery 104 (referred to below as a battery voltage), or some other voltage.

The controller 106 may also obtain stored voltage information, such as voltage information indicative of a trickle-charging threshold for the battery 104. As understood by those of skill in the art, when a battery is recharged, a trickle-charging current may be provided when the battery is nearly fully charged. A trickle-charging current is a small current that recharges a battery without significantly adversely affecting the lifetime of the battery (as may be the case if a larger charge current were applied). Different batteries may have different trickle-charging thresholds. The controller 106 may have access to stored information in memory and/or storage indicative of the trickle-charging threshold of the battery 104. For example, such information may be provided by a manufacturer of the battery 104.

At act 206, the controller 106 determines whether the battery voltage meets or exceeds the trickle-charging threshold for the battery 104. Act 206 may therefore include the controller 106 determining whether the actual, present voltage across the battery 104 (determined based on sensed voltage information obtained at act 204) meets or exceeds the stored trickle-charging threshold for the battery 104 (obtained from storage and/or memory at act 204). If the battery voltage does not meet or exceed the stored trickle-charging threshold (206 NO), and is thus not almost fully charged, the process 200 continues to act 208.

At act 208, the controller 106 turns on (that is, controls to be closed and conducting) the FETs 110, 112 and keeps the converter 108 off. As noted at act 206, if the battery voltage is less than the trickle-charging threshold for the battery 104, then the battery 104 may be considered to be not almost fully charged (for example, less than 95% charged). The BMS 102 may therefore provide a large charging current to the battery 104, referred to as bulk charging. By closing the FETs 110, 112, the controller 106 couples the battery 104 directly across the busses 12, 14, enabling the UPS 10 to provide a full charging current to the battery 104.

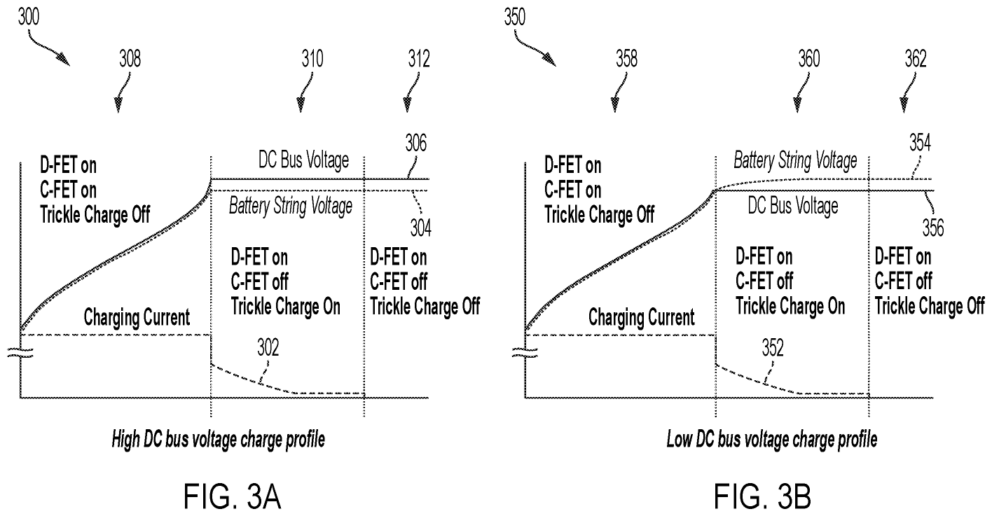

To aid in describing the charging currents, FIGS. 3A and 3B illustrate graphs depicting charge profiles for two different batteries. FIG. 3A illustrates a charge-profile graph 300 for a first battery having a first rated voltage which, as discussed in greater detail below, may be less than a maximum voltage across the busses 12, 14. FIG. 3B illustrates a charge-profile graph 350 for a second battery having a second rated voltage which, as discussed in greater detail below, may be more than a maximum voltage across the busses 12, 14.

The first graph 300 includes a current trace 302 indicating a current provided to the battery 104 (for example, if the battery 104 has a cell chemistry for which the rated voltage is less than the voltage across the busses 12, 14), a battery-voltage trace 304 (“battery trace 304”) indicating a voltage across the battery 104, and a bus-voltage trace 306 (“bus trace 306”) indicating a voltage across the busses 12, 14. The second graph 350 includes a current trace 352 indicating a current provided to the battery 104 (for example, if the battery 104 has a cell chemistry for which a rated voltage is greater than the voltage across the busses 12, 14), a battery-voltage trace 354 (“battery trace 354”) indicating a voltage across the battery 104, and a bus-voltage trace 356 (“bus trace 356”) indicating a voltage across the busses 12, 14.

Each of the graphs 300, 350 includes different charging regions defined by how the controller 106 controls the FETs 110, 112 and converter 108. As discussed above, at act 208, the controller 106 controls the converter 108 to be off and the FETs 110, 112 to be closed and conducting. This state corresponds to a bulk-charging region, denoted as a bulk-charging region 308 in the first graph 300 and a bulk-charging region 358 in the second graph 350. In the bulk-charging regions 308, 358 (which may be substantially similar to one another), a full, bulk charging current is provided to the battery 104, as indicated by the current traces 302, 352. The bus voltage, indicated by the bus traces 306, 356, is controlled by the UPS 10 to be slightly higher than the battery voltage, indicated by the battery traces 304, 354. Because the bus voltage is higher than the battery voltage, a charging current is provided from the UPS 10 the battery 104. The UPS 10 may control the bus voltages to steadily increase such that a constant charging current is provided to the battery 104 as the battery voltage rises.

Returning to the process 200, the process 200 returns from act 208 back to act 206. The controller 106 repeatedly determines whether the battery voltage-which, as indicated by the battery traces 304, 354, rises as a charging current is provided to the battery 104 from the UPS 10—meets or exceeds the trickle-charging threshold. As indicated by the traces 302, 304, 306, 352, 354, 356, the bulk charging current remain at a fixed value throughout the bulk-charging region 308, 358, while the battery voltage and bus voltage steadily increase. Eventually, when the battery voltage increases enough to meet or exceed the trickle-charging threshold (206 YES), the process 200 continues to act 210.

At act 210, the controller 106 determines whether the rated voltage of the battery 104 is equal to or less than the rated voltage of the UPS 10 across the busses 12, 14. For example, if the rated voltage of the battery 104 is 52 V and the rated voltage of the UPS 10 is 54 V, then the controller 106 may determine that the rated voltage of the battery 104 is less than or equal to the rated voltage of the UPS 10 (210 YES). In another example, however, if the rated voltage of the battery 104 is 58 V and the rated voltage of the UPS 10 is 54 V, then the controller 106 may determine that the rated voltage of the battery 104 is not less than or equal to the rated voltage of the UPS 10 (210 NO).

If the controller 106 determines that the rated voltage of the battery 104 is less than or equal to the rated voltage of the UPS 10 (210 YES), then the process 200 continues to act 212. At act 212, the controller 106 controls the D-FETs 112 to remain on, but controls the C-FETs 110 to turn off (that is, be open and non-conducting). The controller 106 also controls the converter 108 to operate in a buck mode.

Because the C-FETs 110 are open and non-conducting, the battery 104 is not directly coupled to the power bus 12 and does not receive a large current directly from the power bus 12. However, the converter 108 is coupled directly to the power bus 12 via the closed D-FETs 112, and provides a trickle-charging current to the battery 104. In particular, the controller 106 operates the converter 108 as a buck converter to adjust the voltage of the power on the bus 12 downward (for example, because the bus voltage exceeds the rated voltage of the battery 104) and provides charging power with the reduced voltage to the battery 104.

A trickle-charging region 310 of the graph 300 corresponds to act 212, that is, a situation in which the bus voltage exceeds the rated voltage of the battery 104 and the converter 108 provides a trickle-charging current to the battery 104. As indicated by the current trace 302, the trickle-charging current is less than the bulk-charging current and decreases over time as the battery 104 is recharged. As indicated by the voltage traces 304, 306, the bus voltage exceeds the battery voltage. After act 212, the process 200 continues to act 216.

Returning to act 210, if the controller 106 determines that the rated voltage of the battery 104 is greater than the rated voltage of the UPS 10 (210 NO), then the process 200 continues to act 214. Act 214 is similar to act 212 in that the controller 106 controls the D-FETs 112 to remain on, but controls the C-FETs 110 to turn off (that is, be open and non-conducting). However, unlike in act 212, at act 214 the controller 106 also controls the converter 108 to operate in a boost mode.

Because the C-FETs 110 are open and non-conducting, the battery 104 is not directly coupled to the power bus 12 and does not receive a large current directly from the power bus 12. However, the converter 108 is coupled directly to the power bus 12 via the closed D-FETs 112, and provides a trickle-charging current to the battery 104. In particular, the controller 106 operates the converter 108 as a boost converter to adjust the voltage of the power on the bus 12 upward (for example, because the bus voltage is less than the rated voltage of the battery 104) and provides charging power with the increased voltage to the battery 104.

A trickle-charging region 360 of the graph 350 corresponds to act 214, that is, a situation in which the bus voltage is less than the rated voltage of the battery 104 and the converter 108 provides a trickle-charging current to the battery 104. As indicated by the current trace 352, the trickle-charging current is less than the bulk-charging current and decreases over time as the battery 104 is recharged. As indicated by the voltage traces 354, 356, the bus voltage exceeds the battery voltage. After act 214, the process 200 continues to act 216.

At act 216, the controller 106 determines whether the battery 104 is fully charged. For example, the controller 106 may obtain battery-voltage information from the sensors 118 indicative of a voltage across the battery 104. The controller 106 may compare the battery-voltage information indicative of the voltage across the battery 104 to the rated voltage of the battery 104. If the controller 106 determines that the voltage across the battery 104 is still less than the rated voltage, then the controller 106 may determine that the battery 104 is not fully charged (216 NO). The process 200 returns to act 210. Acts 210, 212 or 214, and 216 are repeatedly executed until the controller 106 determines that the battery 104 is fully charged (216 YES), at which point the process 200 continues to act 218.

At act 218, the controller 106 turns off the converter 108 and maintains the FETs 110, 112 in their previous states, that is, maintains the D-FETs 112 on and the C-FETs 110 off. Act 218 corresponds to a no-charging region 312 of the first graph 300 and a no-charging region 362 of the second graph 350. As indicated by the current traces 302, 352, no charging current is provided to the battery 104, at least because the converter 108 is off and the C-FETs 110 are open. With the charging of the battery 104 complete, the process 200 may end. In some examples, the controller 106 may repeatedly re-execute the process 200 after the process 200 ends.

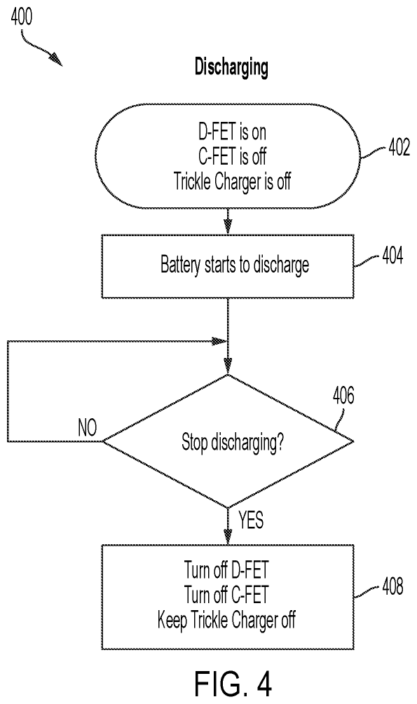

FIG. 4 illustrates a process 400 for discharging the battery 104 according to an example. The battery 104 may be fully charged or partially charged at the beginning of process 400. In some examples, the UPS 10 has determined that the main power source is not providing acceptable power and is therefore drawing power from the battery 104 via the busses 12, 14. The UPS 10 has switched from powering the load using the main power source to powering the load using stored power in the battery 104.

At act 402, the controller 106 controls the BMS 102 to couple the battery 104 to the UPS 10 by controlling the D-FETs 112 to be on (that is, closed and conducting), the C-FETs 110 to be off (that is, open and non-conducting), and the converter 108 to be off. The process 400 then continues to act 404.

At act 404, the battery 104 discharges to the UPS 10. Power may be discharged from the battery 104 to the UPS 10 via the first diode 114 and the closed D-FETs 112. The UPS 10 may use the power provided by the BMS 102 to power the load. The process 400 then continues to act 406.

At act 406, the controller 106 determines whether to stop discharging the battery 104. For example, the controller 106 may determine whether the battery 104 is below a threshold charge level. The controller 106 may determine whether the battery 104 is below the threshold charge level based on a voltage across the battery 104 (for example, based on sensed voltage information from the sensors 118), based on a discharge current from the battery 104 (for example, based on sensed current information from the sensors 118), or based on some other metric. If the controller 106 determines that the battery 104 need not stop discharging (406 NO), then the process 400 returns to act 406. Act 406 is executed until a determination is made to stop discharging the battery 104 (406 YES), at which point the process 400 continues to act 408.

At act 408, the controller 106 turns the C-FETs 110 and D-FETs 112 off and keeps the converter 108 off. The process 400 then ends. At a subsequent point in time (for example, when the UPS 10 regains access to main power), the UPS 10 may again provide power to the busses 12, 14, and the process 200 may be executed to re-charge the battery 104.

Accordingly, the controller 106 may control the converter 108 to provide a trickle-charging current to the battery 104. If the bus voltage is less than the rated voltage of the battery 104, then the controller 106 may operate the converter 108 as a buck converter. If the bus voltage is greater than the rated voltage of the battery 104, then the controller 106 may operate the converter 108 as a boost converter. Thus, for a given bus voltage provided by the UPS 10, the battery pack 100 can implement batteries with a variety of cell chemistries (each of which may have a different rated voltage), and the converter 108 can still provide a trickle-charging current at a desired voltage level to the battery 104. The BMS 102 is thus cell-chemistry-agnostic inasmuch as the BMS 102 may be able to charge a battery having any cell chemistry for any given UPS voltage. Moreover, in some examples, the BMS 102 may be coupled to a battery having one cell chemistry at one point in time, but may later be coupled to a different battery with a different cell chemistry.

As noted above, multiple BMSs may be coupled in parallel with each other to a single bus, even if each BMS is coupled to a battery with a different cell chemistry. Each BMS may individually buck and/or boost voltage from the single bus. For example, FIG. 5 illustrates a power-distribution system 500 having a plurality of battery packs 502a-502d according to an example. Each of the battery packs 502a-502d may be substantially similar to the battery pack 100, and may include a respective battery. Each of the respective batteries may have the same or a different cell chemistry. Each of the battery packs 502a-502d may include a respective BMS coupled in parallel with one another to the bus 12.

Each of the battery packs 502a-502d may include batteries with different cell chemistry. For purposes of example, suppose that the first battery pack 502a includes a battery with a rated voltage of 40 V, the second battery pack 502b includes a battery with a rated voltage of 45 V, the third battery pack 502c includes a battery with a rated voltage of 55 V, and the fourth battery pack 502d includes a battery with a rated voltage of 60 V. Suppose further that the UPS 10 provides a voltage of 50 V on the power bus 12.

In this example, each of the battery packs 502a-502d may provide an independent trickle-charging current to their respective batteries. However, the BMSs of the first battery pack 502a and the second battery pack 502b may operate in a buck mode (for example, because the bus voltage of 50 V exceeds the rated voltages of 40 V and 45 V, respectively) while the third battery pack 502c and the fourth battery pack 502d may operate in a boost mode (for example, because the bus voltage of 50 V is less than the rated voltages of 55 V and 60 V, respectively).

The UPS 10 can also draw power from the battery packs 502a-502d. When discharging, the UPS 10 may draw power from the battery pack with the battery having the highest voltage first, until the voltage of the battery of that battery pack equals the next-highest battery voltage, at which point the UPS 10 may draw power from either or both of the battery packs. For example, the UPS 10 may draw from one or both, sequentially or simultaneously, and so forth. In some examples, the UPS 10 may draw power from the battery packs 502a-502d independent of the voltage levels of the respective batteries. For example, the UPS 10 may draw power from any arbitrary one of the battery packs 502a-502d in any order and/or combination.

Various controllers, such as the controller 106, may execute various operations discussed above. Using data stored in associated memory and/or storage, the controller 106 also executes one or more instructions stored on one or more non-transitory computer-readable media, which the controller 106 may include and/or be coupled to, that may result in manipulated data. In some examples, the controller 106 may include one or more processors or other types of controllers. In one example, the controller 106 is or includes at least one processor. In another example, the controller 106 performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements can readily occur to those skilled in the art. Such alterations, modifications, and improvements are intended to be part of, and within the spirit and scope of, this disclosure. Accordingly, the foregoing description and drawings are by way of example only.

What is claimed is:

1. A battery-management system (BMS) comprising:
a first group of one or more switching devices, each switching device of the first group being configured to be coupled to a power bus;
a second group of one or more switching devices configured to be coupled to a battery, each switching device of the second group being coupled to the first group of one or more switching devices;
a buck/boost charger coupled to the first group of one or more switching devices and being configured to be coupled to the battery, the buck/boost charger being further configured to adjust a voltage of charging power provided to the battery; and
at least one controller configured to control the buck/boost charger to adjust the voltage of the charging power based on a rated voltage of the battery and based on an input voltage of input power received from the power bus.

2. The BMS of claim 1, further comprising one or more diodes including a first diode coupled in parallel with the first group of one or more switching devices, and a second diode coupled in parallel with the second group of one or more switching devices.

3. The BMS of claim 1, wherein the buck/boost charger is coupled in parallel with the second group of one or more switching devices.

4. The BMS of claim 1, wherein the second group of one or more switching devices is configured to be coupled in series with the first group of one or more switching devices between the power bus and the battery.

5. The BMS of claim 1, wherein the at least one controller is further configured to operate the buck/boost charger to boost the voltage of the charging power responsive to determining that the rated voltage of the battery is greater than the input voltage.

6. The BMS of claim 1, wherein the at least one controller is further configured to operate the buck/boost charger to buck the voltage of the charging power responsive to determining that the rated voltage of the battery is less than the input voltage.

7. A method of operating a battery system including a buck/boost charger and being configured to be coupled to a battery, the method comprising:
receiving, at an input of the battery system, input power from a power bus;
determining a voltage of the input power;
determining a rated voltage of the battery;
comparing the voltage of the input power to the rated voltage of the battery; and
operating the buck/boost charger to provide a charging current derived from the input power to the battery, wherein providing the charging current includes controlling the buck/boost charger to adjust the voltage of the input power based on comparing the voltage of the input power to the rated voltage of the battery.

8. The method of claim 7, wherein controlling the buck/boost charger to adjust the voltage of the input power includes controlling the buck/boost charger to boost the voltage of the input power responsive to determining that the voltage of the input power is less than the rated voltage of the battery.

9. The method of claim 7, wherein controlling the buck/boost charger to adjust the voltage of the input power includes controlling the buck/boost charger to buck the voltage of the input power responsive to determining that the voltage of the input power is greater than the rated voltage of the battery.

10. The method of claim 7, further comprising:
operating, at a first time while the battery system is coupled to a first battery having a first rated voltage, the buck/boost charger to provide a first charging current derived from the input power to the first battery, wherein providing the first charging current includes controlling the buck/boost charger to boost the voltage of the input power responsive to determining that the voltage of the input power is less than the first rated voltage of the first battery; and
operating, at a second time while the battery system is coupled to a second battery having a second rated voltage, the buck/boost charger to provide a second charging current derived from the input power to the second battery, wherein providing the second charging current includes controlling the buck/boost charger to buck the voltage of the input power responsive to determining that the voltage of the input power is greater than the second rated voltage of the second battery.

11. A system for charging multiple batteries using a single power bus, the system comprising:
a power bus configured to provide input power having an input voltage; and
a plurality of battery-management systems (BMSs) including a first BMS and a second BMS coupled in parallel with each other, the first BMS and the second BMS being coupled to the power bus and being configured to receive the input power, each BMS of the plurality of BMSs including:
at least one buck/boost charger configured to be coupled to a respective battery;
at least one first switching device coupled to the power bus;
at least one second switching device coupled in parallel with at least one buck/boost charger and coupled to the at least one first switching device, the at least one second switching device being configured to be coupled to the respective battery; and
at least one controller coupled to the at least one first switching device, the at least one second switching device, and the at least one buck/boost charger, the at least one controller being configured to:
determine the input voltage;
determine a rated voltage of the respective battery; and
control the at least one buck/boost charger to provide a charging current derived from the input power to the battery, wherein providing the charging current includes adjusting the input voltage based on the rated voltage of the respective battery.

12. The system of claim 11, wherein the first BMS is configured to be coupled to a first battery having a first rated voltage, and the second BMS is configured to be coupled to a second battery having a second rated voltage different than the first rated voltage.

13. The system of claim 12, wherein the at least one controller of the first BMS is further configured to control the at least one buck/boost charger of the first BMS to boost the input voltage responsive to determining that the input voltage is less than the first rated voltage.

14. The system of claim 13, wherein the at least one controller of the second BMS is configured to control the at least one buck/boost charger of the second BMS to buck the input voltage responsive to determining that the second rated voltage is less than the input voltage.

15. The system of claim 12, wherein the at least one controller of the second BMS is configured to control the at least one buck/boost charger of the second BMS to buck the input voltage responsive to determining that the second rated voltage is less than the input voltage.

16. A method of charging multiple batteries connected to a power bus, the method comprising:
receiving, by a first battery-management system (BMS) coupled to a first battery having a first rated voltage, first input power having an input voltage from the power bus;
comparing the input voltage with the first rated voltage to determine whether the input voltage is greater than or less than the first rated voltage;
operating a first buck/boost charger of the first BMS to adjust the input voltage based on comparing the input voltage with the first rated voltage;
receiving, by a second BMS coupled to a second battery having a second rated voltage, second input power having the input voltage from the power bus;
comparing the input voltage with the second rated voltage to determine whether the input voltage is greater than or less than the second rated voltage; and
operating a second buck/boost charger of the second BMS to adjust the input voltage based on comparing the input voltage with the second rated voltage.

17. The method of claim 16, wherein operating the first buck/boost charger of the first BMS to adjust the input voltage based on comparing the input voltage with the first rated voltage includes boosting the input voltage responsive to determining that the input voltage is less than the first rated voltage.

18. The method of claim 17, wherein operating the second buck/boost charger of the second BMS to adjust the input voltage based on comparing the input voltage with the second rated voltage includes bucking the input voltage responsive to determining that the input voltage is greater than the second rated voltage.

19. The method of claim 16, wherein operating the second buck/boost charger of the second BMS to adjust the input voltage based on comparing the input voltage with the second rated voltage includes bucking the input voltage responsive to determining that the input voltage is greater than the second rated voltage.

20. The method of claim 16, wherein operating the second buck/boost charger of the second BMS to adjust the input voltage based on comparing the input voltage with the second rated voltage includes boosting the input voltage responsive to determining that the input voltage is less than the second rated voltage.
